(19) United States
(12) Patent Application Publication
(10) Pub. No.: US 2012/0278114 A1
(43) Pub. Date: Nov. 1, 2012

(54) METHOD FOR DYNAMICALLY REVERSING BUSINESS FUNCTIONS

(75) Inventors: Andreas KEMMLER, Boennigheim (DE); Torsten KAMENZ, Wiesloch (DE)

(73) Assignee: SAP AG, Walldorf (DE)

(21) Appl. No.: 13/094,114

(22) Filed: Apr. 26, 2011

(51) Int. Cl. G06Q 10/00

(52) U.S. Cl. 705/7.11

(57) ABSTRACT

A method for determining reversibility of a business function performed by a plurality of development objects in a user's system may include determining reversibility of an accessory container object based on a plurality of environmental factors of the user's system, checking a set of conditions specific to the business function to determine whether the business function is reversible, and displaying the business function as reversible.

### FIELD OF THE INVENTION

The present invention is directed to methods for dynamically setting function reversibility among a mixture of business functions that have been made available to customers through different releases of software packages.

### BACKGROUND

Procurement of complex business applications moves toward on-demand and as-needed purchases. Instead of purchasing major releases of a business application every five years or so, a customer may selectively purchase from an annual enhancement package based on the customer's business needs. The customer may choose and purchase components of specific functionalities from the enhancement package for immediate deployment at a reduced cost. Thus, the customer may enhance its business application capabilities timely without incurring unnecessary expenses.

To deploy the selected functionalities of the enhanced package, a user and/or a vendor may need to switch on the selected functionalities. FIG. 1 illustrates the process for the deployment of functionalities to a user's system. A development package 110 as part of an enhancement package is stored in a storage in a user's system. The package 110 may include bundled development objects. Thus, the package 110 includes a set of switchable development objects 112 and switch business configuration sets (SBCS) 114, 116. The set of switchable development objects 112 are a type of development objects that, when deployed, perform business functions. SBCS 114, 116 are container objects that include data entries to be inserted into tables 118 stored in the user's system. For example, the data entries include configuration data to be inserted into a configuration table of the user's system. In addition to contents to be inserted into different tables, SBCS 114, 116 include contents that result in new table entries, updates to existing table entries, and deletions of table entries. SBCS 114, 116 are associated with package 110 through links 120. The process of associating SBCS 114, 116 is achieved by program developers executing specific applications in a development environment to create links 120. These links are stored in an attribute table of SBCS 114, 116 and delivered to the customer as part of the enhancement package.

To deploy business functions to the user's system, a processor in the user's system executes a user interface program to display graphic elements 104, 106 on a hardware display counsel. The displays are organized into sets in accordance with types of business functions. Each set and/or business function is associated with a select element such as a checkbox button. For example, the graphic element 104 includes a display for “Business Function Set 1” and an associated select element. Further, the “Business Function Set 1” includes business functions such as “Advertise Management” and “Contract Account,” each being associated with a select element. Similarly, the graphic element 106 includes a display for the “Business Function Set 2” and an associated select element. Further, the “Business Function Set 2” includes business functions such as “HCM E-Recruit” and “Maternal Management,” each being associated with a select element. When the select elements of a business function set and/or a business function are selected, a corresponding switch is switched on. For example, switches 1, 3, and 5 in the set of switches 108 are switched on in response to the selection of “Business Function Set 1,” “Advertise Management function,” and “HCM E-Recruit” function. The set of switches 108 includes binary bits that, when turned into “1,” indicate that a corresponding business function has been activated.

In response to the activation of a business function by enabling a switch (switch on), the processor is configured to activate the business function corresponding to development objects by making these objects visible and active. From the code development point of view, this means that these objects are executed after they are switched on and activated. In response to the activation or switching-on of switchable development objects 112, SBCS 114, 116 that are also associated with the activated switch (SWITCH1) via development package 110 may also be activated. The activation of the associated SBCS may cause the extraction of the SBCS contents to corresponding tables 118 stored in the user's system.

Previously, the process of extracting table entries contained in SBCS 114, 116 into the tables 118 is not reversible in the sense that once the table entries are inserted into tables 118, they may overwrite contents stored in the table 118. Thus, business functions of earlier versions of enhancement packages that refer to these SBCS may not be reversible.

It may be desirable to grant customers the ability of testing business functions contained in the enhancement package on the customer's development and test systems prior to actual deployment in the customer's productive system. Thus, the latest version of enhancement packages allows SBCS 114, 116 to be reversed so that business functions associated with the new SBCS 114, 116 may be set to be reversible and be capable of switching off after customer evaluation.

### SUMMARY OF INVENTION

Embodiments of the present invention may include a computer-implemented method for determining reversibility of a business function performed by a plurality of development objects in a user's system. The method may include determining reversibility of an accessory container object based on a plurality of environmental factors of the user's system, responsive to a determination that the accessory container object is reversible, checking a set of conditions specific to the business function to determine whether the business function is reversible, and if the business function is reversible, displaying the business function as reversible, and if not, displaying the business function as irreversible.

### BRIEF DESCRIPTION OF THE DRAWINGS OF THE EXAMPLE EMBODIMENTS

FIG. 1 illustrates the process for the deployment of functionalities on to a user's system.

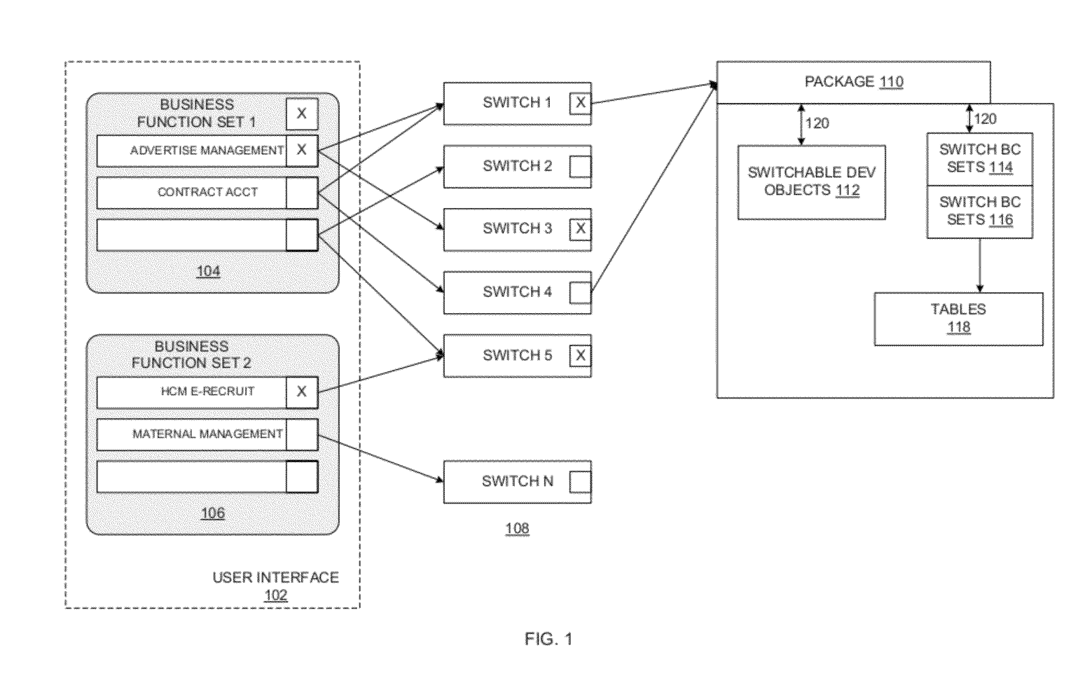

FIG. 2 illustrates a flow diagram for dynamically determining the reversibility of a business function according to an exemplary embodiment of the present invention.

FIG. 3 illustrates a flow diagram for determining reversibility of a business function based on environmental factors of user's system according to an exemplary embodiment of the present invention.

FIG. 4 illustrates a flow diagram for determining reversibility of switch BC sets according to an exemplary embodiment of the present invention.

### DETAILED DESCRIPTION OF THE EXAMPLE EMBODIMENTS

Due to the legacy of code development, a mixture of different versions of business functions may be co-existing in the customer's system. This may be best explained in the following exemplary scenario. In a first release, only a few business functions may be hard-coded as “reversible,” but the majority of the business functions are not labeled as “reversible.” In a subsequent second release, the business functions may be similarly labeled as the first release. In a subsequent third release, the business functions may be released to customers as “reversible.” In addition, a software patch to create reversibility to business functions of the second release may also be released to customers. However, since most business functions of the second release in customer's possession are not labeled as “reversible,” these business functions need a determination of their reversibility based on environmental factors of the user's system. The customer may have activated a portion of the second release of business functions along with SBCS. This portion of business functions may not be reversible. However, the remainder portion of these business functions may have yet been activated by the customer. Since these yet-activated business functions are not hard-coded with a “reversible” flag, they do not appear to be “reversible” once they are activated. Additionally, in the customer's system, development objects installed thereon along with the latest version of SBCS are coded with flags indicating whether these development objects are reversible or not. To reduce confusion and present a consistent service to customers, it is desirable for customers to be able to reverse those yet-activated development objects installed along with SBCS.

To reverse an activated business function, the business function needs to be switched off. Additionally, it is expected that table storing the table entries of the SBCS associated with the activated development object be restored. As discussed above, table entries extracted from the SBCS associated with development objects may have been updated or deleted during activation of the development objects. To have the capability of restoring the table, contents of the original table may need to be archived in an image file on the user's system. Because the earlier version of SBCS is not associated with such an image file, table restoration may not be achieved through pre-images of the table. In contrast, the newer version of SBCS may include a link to an image file so that prior to an update or deletion of a table entry, a pre-image of the table may be archived in the image file so that the pre-image may be used to restore the table when necessary.

Software patches may add reversibility to an earlier version of SBCS. These software patches may be shipped to and installed on the customer's system to enable the earlier version of SBCS to be reversible. These software patches may, upon activation of a business function and before extracting table entries from SBCS and overwriting existing table entries on the customer's system, create pre-images for the existing table contents so that these table contents may be copied into the pre-images. With all these different options on the user's system, it is an object of an embodiment of the present invention to provide a method to determine the reversibility of a business function dynamically based on the environmental factors of the user's system rather than statically based on flags associated with the business function. The environmental factors of the user's system may include availability of the reversibility patches, image files, and attributes of business functions.

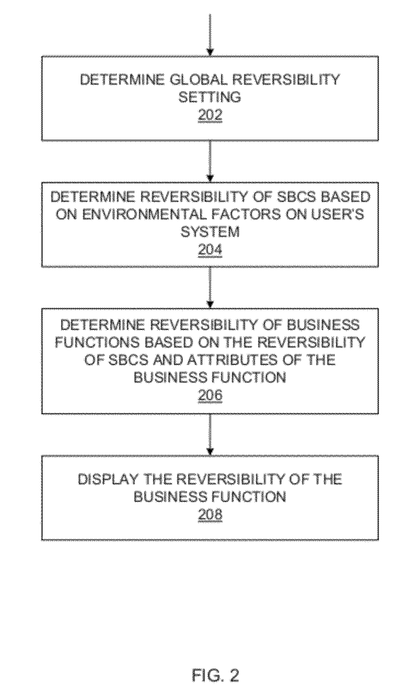

FIG. 2 illustrates a flow diagram for dynamically determining the reversibility of a business function according to an exemplary embodiment of the present invention. At 202, in response to a request to determine the reversibility of a business function, a processor on the user's system may be configured to check a global setting on the user's system to determine whether the global setting allows business functions to be reversed. This global setting may globally affect the reversibility of all business functions. Thus, when the global setting allows business functions on the user's system to be reversed after a testing period, the processor may proceed further.

At 204, in response to a determination that the global setting allows for a reversal of business functions, the processor may be configured to determine the reversibility of SBCS associated with the development package and the business function contained therein based on environmental factors on user's system. The environmental factors may include the availability of certain patches that may convert the earlier version of SBCS into a reversible SBCS and the availability of image files associated with the SBCS.

At 206, in response to a determination that the SBCS may be reversed, the processor may be configured to determine the reversibility of the business function based on certain attributes of the development objects that, when activated, perform the business function. These attributes of the development objects may specify conditions under which the corresponding business function may be reversed or switched off.

At 208, in response to a determination that attributes of the business functions allow them to be reversed, the processor may proceed to prepare and display the business function as reversible. The preparation of the business function may include creating image files for the business function and further associating the created image files with SBCS. Thus, these business functions may be reversed after they are activated in the future. Further, the processor may display an indicator on a display counsel of the reversibility.

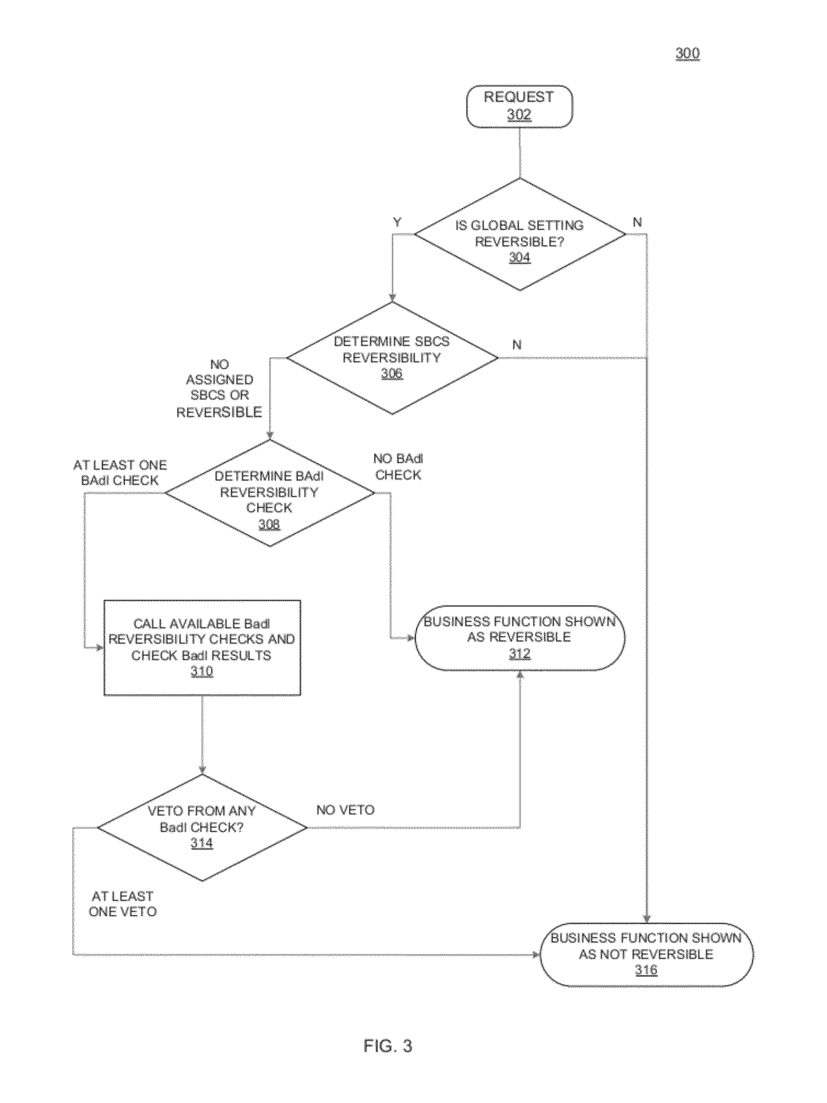

FIG. 3 illustrates a flow diagram for dynamically determining reversibility of a business function based on environmental factors of the user's system according to an exemplary embodiment of the present invention. A processor on the user's system may be configured to receive request 302 for determining reversibility of a business function. The request 302 may be triggered by a deployment of a new enhancement package. Alternatively, the request 302 may be triggered by another request to activate the business function. At 304, the processor may be configured to check a global setting of the user's system to determine whether the user's system globally allow for a reversal of business functions. If the global setting does not allow for such a reversal, a user interface may display information to show that the business function as not reversible.

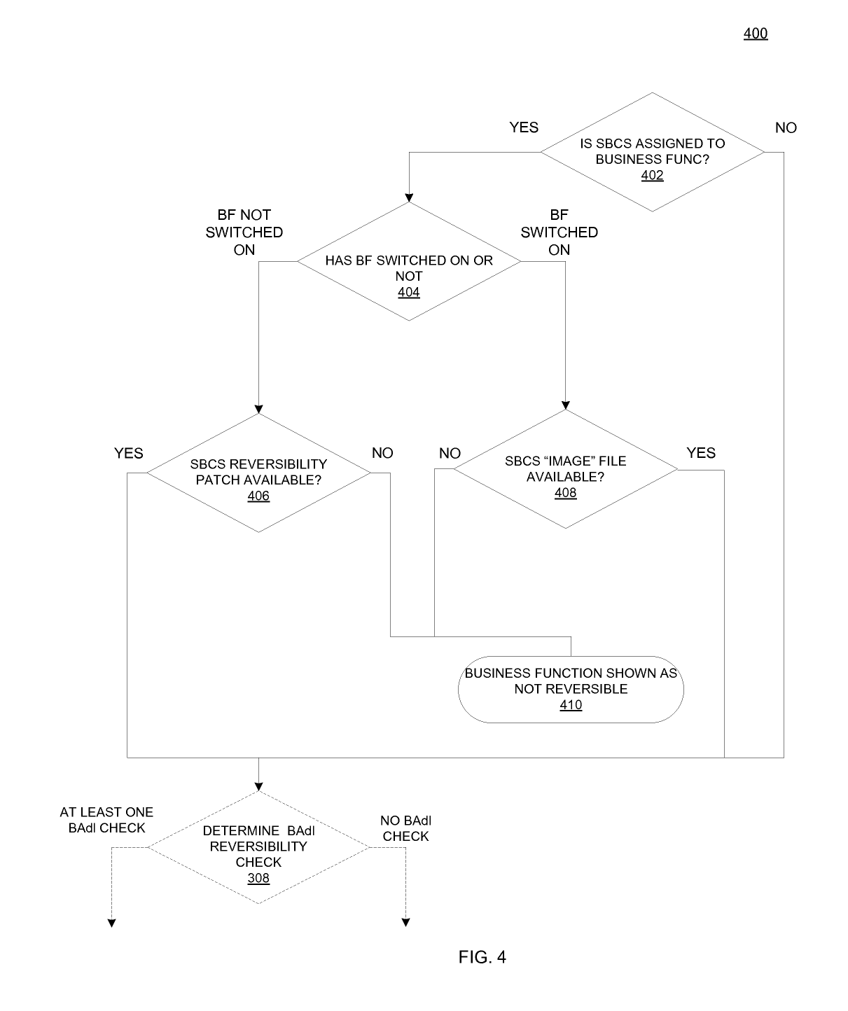

If the global setting allows for such a reversal, at 306, the processor may be configured to search for SBCS that are associated with the business function via a development package and determine whether these associated SBCS are reversible. For clarity, an embodiment of the process to determine whether these associated SBCS are reversible is illustrated in FIG. 4.

FIG. 4 illustrates a flow diagram for determining reversibility of switch BC sets (SBCS) according to an exemplary embodiment of the present invention. At 402, a processor may be configured to determine whether any SBCS are associated to the business function. If it is determined that there is no SBCS associated to the business function, the business function is not constrained by SBCS, and the processor may proceed to step 308 to determine the reversibility of the business function. However, if it is determined that there are SBCS associated to the business function, at 404, the processor is configured to determine whether the business function has been activated (or switched on). If it is determined that the business function has been activated, at 408, the processor may be configured to determine whether the associated SBCS are linked to an image file. If the associated SBCS are not linked to any image files, the business function may be an activated business function associated with an earlier version of SBCS. Thus, the business function is displayed as not reversible at 410. However, if the associated SBCS are linked to an image file, the business function may be an activated business function whose reversibility may be further determined at 308. Referring back to 404, if it is determined that the business function has not been activated (or switched on), at 406, the processor may be configured to determine whether SBCS reversibility patches are available in the user's system. These reversibility patches may include codes that may be used to create image files for SBCS. In one embodiment, these patches may be generally applicable to all SBCS. Thus, if it is determined that SBCS reversibility patches are not available on the user's system, the business function may be displayed as not reversible at 410. However, if it is determined that SBCS reversibility patches are available on the user's system, the processor may proceed to determine the reversibility of the business function at 308.

Referring back to step 306 of FIG. 3, if it is determined that the associated SBCS is reversible or the business function does not have an associated SBCS, at 308, the processor may be configured to perform checks specific to the business function to determine whether the business function is reversible. The business function specific checks may be applicable for certain business functions, but not all business functions. If a business function does not include further specific checks, the business function may be shown as reversible at 312. However, if the business function includes further specific checks, the processor may be configured to perform these specific checks at 310. These checks may be formulated in the form of conditions. In one exemplary embodiment, the condition may be in the form of “business functions which are reversible as long as a certain data conversion took place.” In another exemplary embodiment, the condition may be in the form of “business functions which are reversible as long as they are not yet transported into the productive system.” In another exemplary embodiment, the condition may be in the form of “business functions which are reversible only when certain customized settings are reset to the initial value.” These conditions may be implemented by using extensions such as Business Add Ins (BAdIs) to the business functions. These BAdIs may be implemented by the developers or alternatively, by third parties. At 314, if it is determined that there is no veto from any of the business function specific checks, the business function may be displayed as reversible at 312. However, if it is determined that there is at least one veto from the checks, the business function may be displayed as irreversible at 316.

Although the present invention has been described with reference to particular examples and embodiments, it is understood that the present invention is not limited to those examples and embodiments. Further, those embodiments may be used in various combinations with and without each other. The present invention as claimed therefore includes variations from the specific examples and embodiments described herein, as will be apparent to one of skill in the art.

1. A computer-implemented method for determining reversibility of reversing a business function from a deployed state to a prior undeployed state, the business function being performed by a plurality of development objects in a user's system, the method comprising:
determining, by a processor, reversibility of an accessory container object based on a plurality of environmental factors of the user's system, the accessory container object being associated with the development objects via a development package containing both the development objects and the accessory container object;
responsive to a determination that the accessory container object is reversible, checking, by the processor, a set of conditions specific to the business function to determine whether the business function is reversible; and
if the business function is reversible, displaying, by the processor, the business function as reversible,
if the business function is not reversible, displaying, by the processor, the business function as irreversible.

2. The method of claim 1, wherein the business function is part of an enhancement package that is selectively activated by a user on the user's system.

3. The method of claim 2, wherein the accessory container object includes data entries associated with the business function, and responsive to an activation of the business function, the data entries are extracted from the accessory container object to tables stored on the user's system.

4. The method of claim 3, wherein the tables include a configuration table of the user's system.

5. The method of claim 3, wherein the data entries are one of updated and deleted after being extracted.

6. The method of claim 3, wherein the determining of the reversibility of the accessory container object further includes:
determining whether the business function is activated;
if the business function is activated, determining whether the accessory container object is linked to an image file for storing a pre-image of the tables to which a content of the accessory container object is extracted;
if the accessory container object is not linked to the image file, displaying the business function as irreversible;
if the accessory container object is linked to the image file, determining the business function as reversible;
if the business function is not activated, determining whether a reversibility patch exists in the user's system, wherein the reversibility patch when executed creates the pre-image of the tables to which the accessory container object is extracted;
if the reversibility patch does not exist in the user's system, displaying the business function as irreversible;
if the reversibility patch exists, determining the business function as reversible.

7. The method of claim 1, wherein the checking of the set of conditions includes
determining any one of the set of conditions is not met;
if any one of the set of conditions is not met, displaying the business function as irreversible;
otherwise, displaying the business function as reversible.

8. The method of claim 7, wherein the set of conditions includes whether the plurality of development objects that performs the plurality of business functions are transported into a productive system.

9. A machine-readable non-transitory medium stored thereon executable codes that, when executed, perform a method for determining reversing a business function from a deployed state to a prior undeployed state, the business function being performed by a plurality of development objects in a user's system, the method comprising:
determining reversibility of an accessory container object assigned to the plurality of development objects based on a plurality of environmental factors of the user's system, the accessory container object being associated with the development objects via a development package containing both the development objects and the accessory container object;
responsive to a determination that the accessory container object is reversible, checking a set of conditions specific to the business function to determine whether the business function is reversible;
if the business function is reversible, displaying the business function as reversible,
if the business function is not reversible, displaying the business function as irreversible.

10. The machine-readable medium of claim 9, wherein the business function is part of an enhancement package that is selectively activated by a user on the user's system.

11. The machine-readable medium of claim 10, wherein the accessory container object includes data entries associated with the business function, and responsive to an activation of the business function, the data entries are extracted from the accessory container object to tables stored on the user's system.

12. The machine-readable medium of claim 11, wherein the tables include a configuration table of the user's system.

13. The machine-readable medium of claim 11, wherein the data entries are one of updated and deleted after being extracted.

14. The machine-readable medium of claim 11, wherein the determining of the reversibility of the accessory container object further includes:
determining whether the business function is activated;
if the business function is activated, determining whether the accessory container object is linked to an image file for storing a pre-image of the tables to which a content of the accessory container object is extracted;
if the accessory container object is not linked to the image file, displaying the business function as irreversible;
if the accessory container object is linked to the image file, determining the business function as reversible;
if the business function is not activated, determining whether a reversibility patch exists in the user's system, wherein the reversibility patch when executed creates the pre-image of the tables to which the accessory container object is extracted;
if the reversibility patch does not exist in the user's system, displaying the business function as irreversible;
if the reversibility patch exists, determining the business function as reversible.

15. The machine-readable medium of claim 9, wherein the checking of the set of conditions includes
determining any one of the set of conditions is not met;
if any one of the set of conditions is not met, displaying the business function as irreversible;
otherwise, displaying the business function as reversible.

16. The machine-readable medium of claim 15, wherein the set of conditions includes whether the plurality of development objects that performs the plurality of business functions are transported into a productive system.
